(19) United States
(12) Patent Application Publication
(10) Pub. No.: US 2008/0130435 A1
(43) Pub. Date: Jun. 5, 2008

(54) Disc Drive Apparatus With Non-Linear Observer

(75) Inventors: Marcel Francois Heertjes, Eindhoven (NL); Carsten Patz, Stuttgart (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,381

(22) PCT Filed: Jan. 19, 2006
(86) PCT No.: PCT/IB06/50203

§ 371 Date: Jul. 20, 2007

(30) Foreign Application Priority Data
Jan. 21, 2005 (EP) 05100366.3

(51) Int. Cl. G11B 5/09

(52) U.S. Cl. 369/47.15

(57) ABSTRACT

An optical disc drive apparatus (1) comprises: a read/write element (34) to be positioned with respect to the disc (2), and a detector (35) for generating a read signal (SR); actuator means (50) for controlling the positioning of said read/write element. A control circuit (90) receives said read signal and generates an actuator control signal (SCR), the control circuit having at least one variable gain (γ). Said control circuit, actuator means, read/write element, and detector define a control loop (100) having a critical frequency (cocp). A non-linear state estimator (350) is used to selectively set said gain (γ) to a first value for signal components having a frequency in a predefined range corresponding to said critical frequency (COCP) and to a second value for signal components having a frequency outside said range, said first value being lower than said second value.

The present invention relates in general to the field of controlling a parameter of a process or an apparatus. In a particular application, the present invention relates to the field of controlling a position of an object, more particularly the radial position of an objective lens of an optical disc drive, and the invention will be specifically explained for this application in the following description. It is, however, noted that the present invention is not limited to such an application. For instance, the gist of the invention also applies to magnetic discs, and even applies more generally to the field of non-linear control.

As is commonly known, an optical storage disc comprises at least one track, either in the form of a continuous spiral or in the form of multiple concentric circles, constituting a storage space in which information may be stored in the form of a data pattern. Optical discs may be of the read-only type, in which information that can only be read by a user is recorded during manufacture. The optical storage disc may also be of a writeable type, in which information may be stored by a user. For writing information in the storage space of the optical storage disc, or for reading information from the disc, an optical disc drive comprises, on the one hand, rotating means for receiving and rotating an optical disc, and, on the other hand, optical means for generating an optical beam, typically a laser beam, and for scanning the storage track with said laser beam. Since the technology of optical discs in general, the way in which information can be stored in an optical disc, and the way in which optical data can be read from an optical disc is commonly known, it is not necessary to describe this technology in more detail hereinafter.

For rotating the optical disc, an optical disc drive typically comprises a motor, which drives a hub engaging a central portion of the optical disc. Usually, the motor is implemented as a spindle motor, and the motor-driven hub may be arranged directly on the spindle of the motor.

For optically scanning the rotating disc, an optical disc drive comprises a light beam generator device (typically a laser diode), an objective lens for focusing the light beam in a focal spot on the disc, and an optical detector for receiving the light reflected from the disc and for generating an electric detector output signal. The optical detector comprises multiple detector segments, each segment providing an individual segment output signal.

During operation, the light beam should remain focused on the disc. To this end, the objective lens is arranged in an axially displaceable manner, and the optical disc drive comprises focal actuator means for controlling the axial position of the objective lens. Furthermore, the focal spot should remain aligned with a track or should be capable of being positioned with respect to a new track. To this end, at least the objective lens is mounted in a radially displaceable manner, and the optical disc drive comprises radial actuator means for controlling the radial position of the objective lens.

In many disc drives, the objective lens is arranged in a tiltable manner, and such an optical disc drive comprises tilt actuator means for controlling the tilt angle of the objective lens.

For controlling these actuators, the optical disc drive comprises a controller, which receives an output signal from the optical detector. From this signal, hereinafter also referred to as read signal, the controller derives one or more error signals, such as, for instance, a focus error signal, a radial error signal, and, on the basis of these error signals, the controller generates actuator control signals for controlling the actuators so as to reduce or eliminate position errors.

In the process of generating actuator control signals, the controller has a certain control characteristic. Such a control characteristic is a feature of the controller, which may be described as the way in which the controller behaves in response to detecting position errors.

In practice, position errors may be caused by different types of disturbances. The two most important classes of disturbances are:

1) disc defects
2) external shocks and (periodic) vibration.

The first category comprises internal disc defects such as black dots, pollution such as fingerprints, damage such as scratches, etc. The second category comprises shocks caused by an object colliding with the disc drive, but shocks and vibrations are mainly to be expected in portable disc drives and automobile applications.

A problem in this respect is that adequate handling of disturbances of the first category requires a different control characteristic than adequate handling of disturbances of the second category. Conventionally, the controller of a disc drive has a fixed control characteristic, which is either specifically adapted to adequately handle disturbances of the first category (in which case error control is not optimal for disturbances of the second category), or specifically adapted to adequately handle disturbances of the second category (in which case error control is not optimal for disturbances of the first category), or the control characteristic is a compromise (in which case error control is not optimal for disturbances of the first category as well as for disturbances of the second category). As long as a controller applies a linear control technique, there is always a compromise between low-frequency disturbance rejection and high-frequency sensitivity to noise.

In the state of the art, it has already been proposed to change the control characteristic of the controller, depending on the type of disturbance experienced. For instance, reference is made to U.S. Pat. No. 4,722,079, which discloses a disc drive apparatus wherein the gain of the controller is adapted.

Apart from determining the type of disturbance and adapting the control characteristics in relation to the type of disturbance, it is possible to perform a quantitative assessment of the disturbance, and to adapt the control characteristics to the severity of the disturbance. For instance, in the case of a mechanical shock, the controller gain may not only be increased, but the amount of the increase may depend on the strength of the shock. The higher the controller gain, the better the drive can resist a strong mechanical shock. Thus, the performance of the drive in the case of strong mechanical shocks depends on the maximal gain increase.

A general problem in this respect is that the gain cannot be increased in an unlimited way; if the gain is set too high, the control loop of the controller may get unstable.

Thus, it is a general object of the present invention to provide a method of further increasing the controller gain without increasing the risk of instability of the controller.

It is a further object of the present invention to provide a method of dynamically amending a controller characteristic so as to reduce the risk of instability of the controlled system.

According to an important aspect of the present invention, the gain increase in the case of a shock not only depends on the strength of the shock but also on the characteristic frequency of the shock. If the shock has a relatively low or a relatively high associated frequency, the gain is increased to a relatively large extent. If the shock has an associated frequency in a predetermined frequency range associated with instability risks, the gain is increased to a relatively small extent. In fact, in said predetermined frequency range, the gain may be kept constant or it may even be reduced.

Thus, the controller shows a non-linear behavior with a variable gain. This already offers an improvement: in the case of large error signals induced by large low-frequency shocks and vibrations, the controller gain is increased, whereas in the absence of shocks and vibrations but in the presence of high-frequency noise or disc surface defects, the original controller gain is restored.

However, it may happen that low-frequency disturbances and high-frequency defects occur simultaneously. In such a case, the increased gain would lead to an undesirable increased sensitivity to the high-frequency defects. A further object of the present invention is to overcome this problem.

An obvious approach to attacking this problem would be to add a low-pass filter element to filter out the high-frequency disturbances. However, this would unavoidably affect the non-linear control design and thus affect the stability of the system, so that it would lead to a reduction of the maximum gain that can be used to handle low-frequency disturbances.

To further improve the controller while avoiding the above problem, according to a second important aspect of the present invention, a non-linear state estimator (also indicated as observer) is proposed so as to further improve the controller while avoiding the above problem. The non-linear state estimator proposed by the present invention has the important characteristic that it suppresses high-frequency components without significantly affecting the stability of the non-linear control system.

It is noted that US-2004/0037193 discloses the use of a linear Kalman filter in a control system for controlling the position of an optical pickup.

It is noted that U.S. Pat. No. 5,982,721 discloses an optical disc drive system including a sliding mode controller. The sliding mode controller requires a position signal and a velocity signal, which are provided by a linear estimator.

These and other aspects, features and advantages of the present invention will be further explained with reference to the drawings, in which identical reference numerals denote the same or similar parts, and in which:

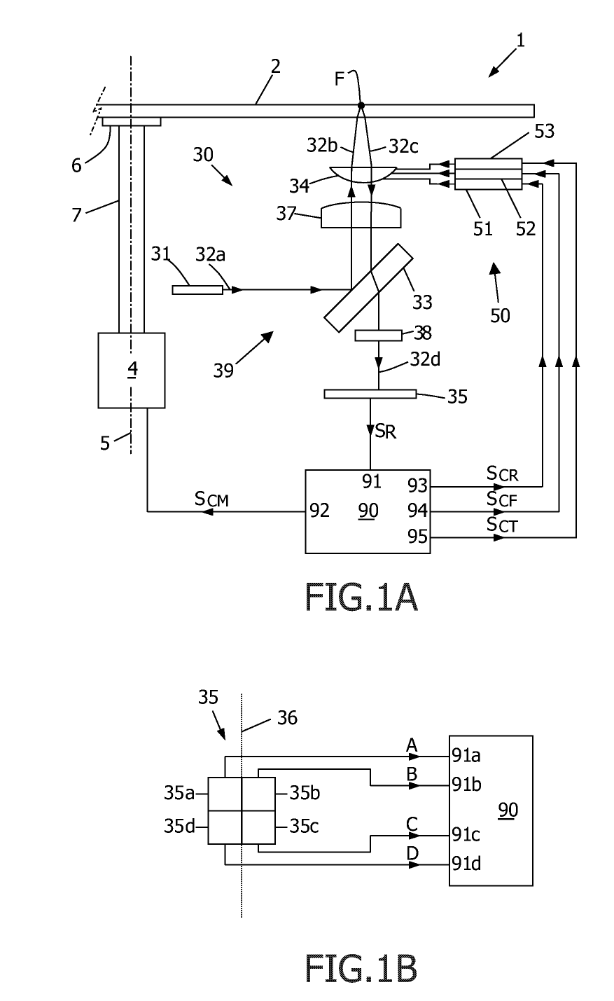

FIG. 1A schematically illustrates relevant components of an optical disc drive apparatus;

FIG. 1B schematically illustrates an embodiment of an optical detector in more detail;

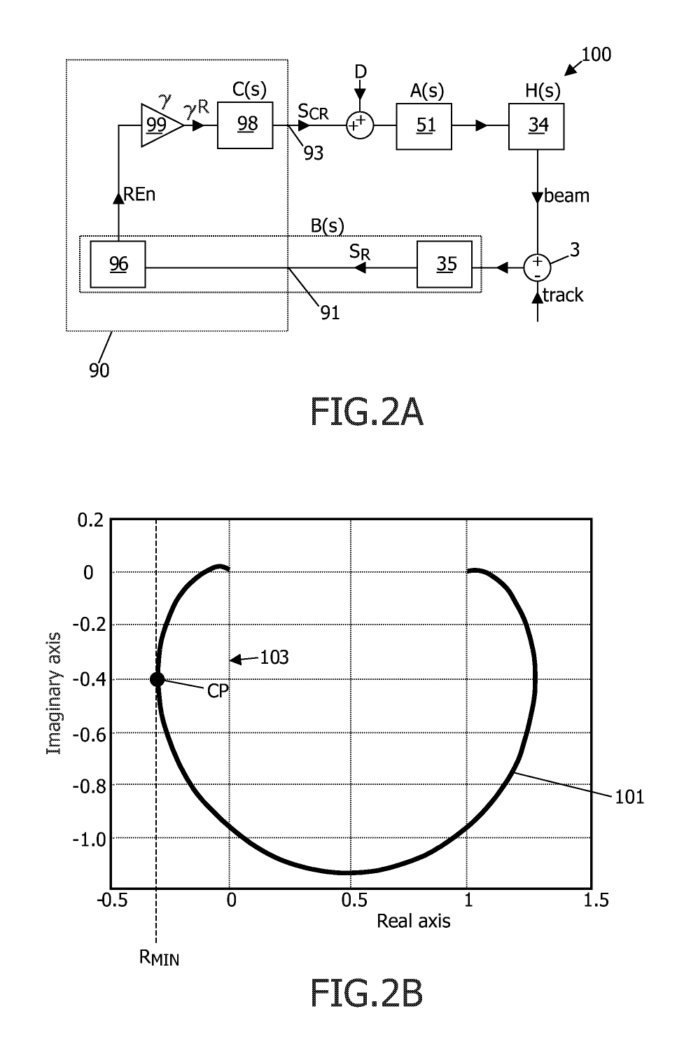

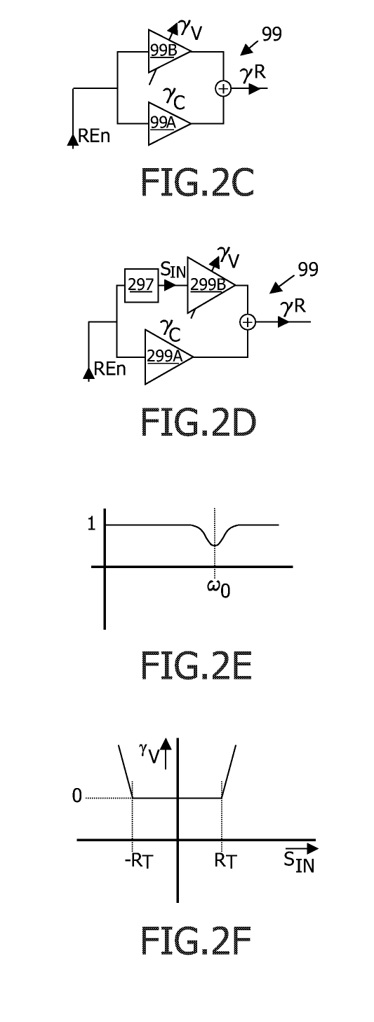

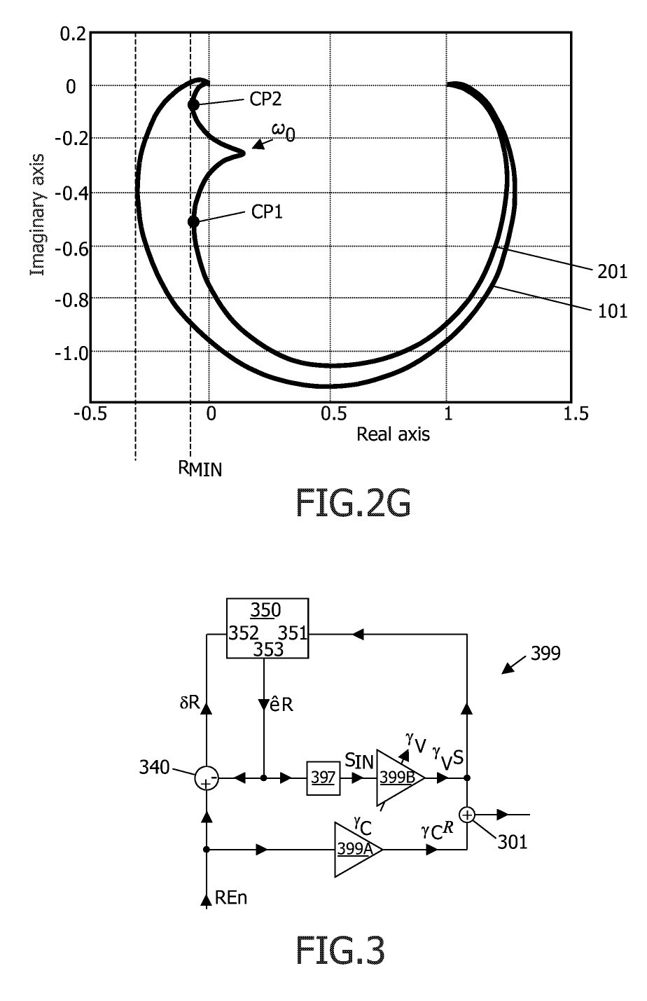

FIG. 2A is a block diagram, schematically illustrating a tracking control loop;

FIG. 2B is a graph showing a Nyquist plot of the overall transfer function of a closed loop without the invention being implemented;

FIG. 2C is a block diagram of a replacement circuit for an amplifier;

FIG. 2D is a block diagram of a replacement circuit for an amplifier;

FIG. 2E is a graph illustrating a possible frequency characteristic of a dynamic filter suitable for use in implementing the present invention;

FIG. 2F is a graph schematically illustrating variable gain behavior;

FIG. 2G is a graph showing a Nyquist plot of the overall transfer function of a closed loop implemented according to the invention;

FIG. 3 is a block diagram of a replacement circuit for an amplifier implemented according to the invention.

FIG. 1A schematically illustrates an optical disc drive apparatus 1, suitable for storing information on or reading information from an optical disc 2, typically a DVD or a CD. For rotating the disc 2, the disc drive apparatus 1 comprises a motor 4 fixed to a frame (not shown for the sake of simplicity), defining a rotation axis 5.

The disc drive apparatus 1 further comprises an optical system 30 for scanning tracks (not shown) of the disc 2 by an optical beam. More specifically, in the example of the arrangement illustrated in FIG. 1A, the optical system 30 comprises a light beam generating means 31, typically a laser such as a laser diode, arranged to generate a light beam 32. Different sections of the light beam 32, following an optical path 39, will hereinafter be indicated by a character a, b, c, etc. added to the reference numeral 32.

The light beam 32 passes a beam splitter 33, a collimator lens 37 and an objective lens 34 to reach (beam 32b) the disc 2. The objective lens 34 is designed to focus the light beam 32b in a focal spot F on a recording layer (not shown for the sake of simplicity) of the disc. The light beam 32b is reflected from the disc 2 (reflected light beam 32c) and passes the objective lens 34, the collimator lens 37, and the beam splitter 33, to reach (beam 32d) an optical detector 35. In the case illustrated, an optical element 38 such as, for instance, a prism is interposed between the beam splitter 33 and the optical detector 35.

The disc drive apparatus 1 further comprises an actuator system 50, which comprises a radial actuator 51 for radially displacing the objective lens 34 with respect to the disc 2. Since radial actuators are known per se, and the present invention does not relate to their design and functioning, it is not necessary to discuss them in great detail.

To achieve and maintain correct focusing, exactly at the desired location of the disc 2, said objective lens 34 is mounted in an axially displaceable manner, while the actuator system 50 also comprises a focal actuator 52 arranged to axially displace the objective lens 34 with respect to the disc 2. Since focal actuators are known per se, and their design and operation is no subject of the present invention, it is not necessary to discuss them in great detail.

To achieve and maintain a correct tilt position of the objective lens 34, the objective lens 34 is mounted pivotally, while the actuator system 50 also comprises a tilt actuator 53 arranged to pivot the objective lens 34 with respect to the disc 2. Since tilt actuators are known per se, and their design and operation is no subject of the present invention, it is not necessary to discuss them in great detail.

It is further noted that means for supporting the objective lens with respect to an apparatus frame, and means for axially and radially displacing the objective lens, as well as means for pivoting the objective lens, are generally known per se. Since the design and operation of such supporting and displacing means is no subject of the present invention, it is not necessary to discuss them in great detail.

It is further noted that the radial actuator 51, the focal actuator 52 and the tilt actuator 53 may be implemented as one integrated actuator.

The disc drive apparatus 1 further comprises a control circuit 90 having a first output 92 connected to a control input of the motor 4, a second output 93 coupled to a control input of the radial actuator 51, a third output 94 coupled to a control input of the focal actuator 52, and a fourth output 95 coupled to a control input of the tilt actuator 53. The control circuit 90 is designed to generate, at its first output 92, a control signal S_{CM} for controlling the motor 4, to generate, at its second control output 93, a control signal S_{CR} for controlling the radial actuator 51, to generate, at its third output 94, a control signal S_{CF} for controlling the focal actuator 52, and to generate, at its fourth output 95, a control signal S_{CT} for controlling the tilt actuator 53.

The control circuit 90 has a read signal input 91 for receiving a read signal S_{R} from the optical detector 35.

FIG. 1B illustrates that the optical detector 35 comprises a plurality of detector segments, in this case four detector segments 35a, 35b, 35c, 35d, capable of providing individual detector signals A, B, C, D, respectively, indicating the amount of light incident on each of the four detector segments. The detector segments 35a, 35b, 35c, 35d, also referred to as central aperture detector segments, are arranged in a four-quadrant configuration. A center line 36, separating the first and fourth segments 35a and 35d from the second and third segments 35b and 35c, has a direction corresponding to the track direction. Since such a four-segment detector is known per se, it is not necessary to give a more detailed description of its design and functioning.

FIG. 1B also illustrates that the read signal input 91 of the control circuit 90 actually comprises a plurality of inputs for receiving all individual detector signals. Thus, in the illustrated case of a four-quadrant detector, the read signal input 91 of the control circuit 90 actually comprises four inputs 91a, 91b, 91c, 91d for receiving said individual detector signals A, B, C, D, respectively. The control circuit 90 is designed to process said individual detector signals A, B, C, D, in order to derive data and control information therefrom, as will be clear to a person skilled in the art. For instance, a normalized radial error signal REn can be defined in accordance with:

$$REn = \frac{( A + D ) - ( B + C )}{A + B + C + D} \qquad ( 1 )$$

Furthermore, a normalized focus error signal FEn can be defined in accordance with:

$$FEn = ( \frac{A - D}{A + D} ) - ( \frac{B - C}{B + C} ) \qquad ( 2 )$$

Each of these signals REn and FEn is a measure of a certain kind of asymmetry of the central optical spot on the detector 35, and hence they are sensitive to displacement of the optical scanning spot with respect to the disc.

It is noted that, depending on the design of the optical detector, different definitions of error signals may be used.

The present invention will hereinafter be explained specifically for the case of controlling the radial actuator 51, but it should be clear that the same, or at least a similar explanation applies in the case of focus control, tilt control, etc. The explanation will first deal with linear control and then with non-linear control.

FIG. 2A is a simplified block diagram schematically illustrating a tracking control loop 100. The control circuit 90 generates a control signal S_{CR} for the radial actuator 51, which causes a displacement of the lens 34. A transfer function of the radial actuator 51, representing the relationship between control signal S_{CR} and the resulting actuator force is indicated as A(s).

A transfer function of the lens 34, representing the relationship between the actuator force and the resulting lens displacement is indicated as H(s); it is noted that, in a simplified model, H may be written as:

$$H ( s ) = \frac{1}{{ms}^{2}}$$

wherein m indicates the mass of the lens 34.

The displacement of the lens 34 causes a change in the optical beam position, indicated as signal “beam”. In the meantime, also the position of a track to be followed may have changed, indicated as signal “track”, which represents a target position for the beam. The difference between the actual beam position and the target beam position, represented by a subtractor 3, results in a characteristic change in the reflected light beam as received by the detector 35, thus resulting in a characteristic change in the optical read signal S_{R}, from which a radial error signal can be calculated. An error signal calculator 96 of the control circuit 90 calculates the radial error signal REn from the optical read signal S_{R}. A transfer function of the combination of detector 35 and error signal calculator 96, representing the relationship between the beam displacement with respect to a track, on the one hand, and radial error signal REn, on the other hand, is indicated as B(s). It is noted that the transfer (gain) of error signal calculator 96 is equal to 1, by definition, because this circuit only calculates a relative positional error from the absolute beam and track positions.

A control signal generator part 98 of the control circuit 90, for instance, a PID controller, generates the control signal S_{CR} on the basis of the radial error signal REn. A transfer function of the control signal generator 98, representing the relationship between radial error signal REn and control signal S_{CR}, is indicated as C(s).

It is assumed that all of said transfer functions are fixed.

FIG. 2A further shows that the control circuit 90 may comprise an amplifier 99 having a gain γ, in this example shown as being arranged between the error signal calculator 96 and the control signal generator 98. The signal received by the control signal generator 98 from the amplifier 99 is indicated as amplified error signal γR.

In practice, the control system may be subjected to disturbances, which are represented as a disturbance signal D in FIG. 2A, added to the control loop at the input of actuator 51. The influence of disturbances may be described by a closed loop transfer function G(s), describing the transfer of a small disturbance D at the input of actuator 51 to the output of the control signal generator 98 in a case when the servo loops are in operation. As should be clear to a person skilled in the art, a closed loop transfer function G(s) can be written as:

$$G ( s ) = \frac{γ \cdot X ( s )}{1 + γ \cdot X ( s )}$$

wherein X(s)=C(s)·A(s)·H(s)·B(s).

FIG. 2B is a graph showing a Nyquist plot, indicated by reference numeral 101, of the frequency response of an example of a closed loop transfer function G(s) of the control loop 100. The horizontal axis represents the real part Re(G(jω)), while the vertical axis represents the imaginary part Im(G(jω)). The upper right end of the curve 101 corresponds to ω=0, while the upper left end of the curve 101 corresponds to ω=∞.

In FIG. 2B, a critical point CP, indicated at 103, is defined as the point of the closed loop transfer function G(s) wherein the real part Re(G(jω)) has the lowest value R_{MIN}. The frequency corresponding to this critical point CP will be indicated as critical frequency ω_{CP}. As will be clear to a person skilled in the art, the value of R_{MIN} determines a maximum for the gain γ: the lower R_{MIN} (i.e. the higher |R_{MIN}|), the lower the maximum for γ can be. If γ is above this maximum when a shock occurs having a frequency in the range of the critical frequency ω_{CP}, the system may get unstable.

As will be clear to a person skilled in the art, the control circuit 90 should have such a design that the system is stable in the linear situation of FIG. 2A. This implies a limitation of the gain γ. This may be unsatisfactory in the case of shocks and vibrations. Since shocks and vibrations typically involve frequencies in a range much lower than the critical frequency ω_{CP}, a higher gain would be possible without a risk of reduced stability. To accommodate both the requirement of limited gain for disturbances having a frequency in the range of the critical frequency ω_{CP} and the requirement of high gain in the case of shocks and vibrations, the control circuit 90 has variable control characteristics. More specifically, the control circuit 90 comprises an amplifier 99 with variable gain γ, which gain γ can be written as γ=γ_{C}+γ_{V}, wherein γ_{C} indicates a constant part of the gain while γ_{V} indicates a variable part of the gain. FIG. 2C is a block diagram of a replacement circuit for the amplifier 99, showing the amplifier 99 as a parallel combination of a constant amplifier 99A having a constant gain γ_{C} and a variable amplifier 99B having a variable gain γ_{V}. It should be clear that, when γ_{V}=0, the overall gain γ of the amplifier 99 is fully determined by the constant gain γ_{C}, which is set with a view to stability requirements, as mentioned above. In other words, it may be assumed that the system is stable when γ_{V}=0.

The control circuit 90 is capable of detecting shocks and adapting its control characteristics when a shock situation is detected. More particularly, the control circuit 90 is designed to increase γ_{V} in the case of a shock being detected, wherein the magnitude of the gain increase depends on the magnitude of the shock experienced. It is noted that control circuits employing shock detection and amending their gain in response are known per se; therefore, it is not necessary to describe this aspect in more detail. Particularly, the method of shock detection is not important in this respect, because the present invention can be implemented in conjunction with any kind of shock detection method, although methods are preferred which allow a quantitative shock magnitude detection.

The shock detection capability may be illustrated, and even implemented, as a separate shock detector (for instance, a mechanical shock detector) having an output controlling the setting of the variable amplifier 99B, in which case the variable amplifier 99B would be a controllable amplifier having a gain determined by an input control signal. However, in the present illustration, the shock detection capability is considered to be implemented in a dynamic filter 297 connected in the input data path of the variable amplifier 99B. Thus, the shock detection capability is based on an analysis of the frequency content of the input signal as received by the variable amplifier 99B (i.e. the frequency content of the radial error signal in this example). This is illustrated in FIG. 2D, which is a block diagram of a replacement circuit for the amplifier 99 of FIG. 2A.

The filter action of the dynamic filter 297 can be considered as introducing a frequency-dependent attenuation F(s); the new closed loop transfer function G′(s) can be written as G′(s)=G(s)·F(s). The dynamic filter 297 is designed to selectively suppress frequencies in the range of the critical frequency ω_{CP}. Suitably, the dynamic filter 297 is designed as a band-reject filter or notch filter, having a central frequency ω₀ approximately equal to the critical frequency ω_{CP}, as illustrated in FIG. 2E. It is noted that the filter 297 may also be designed as a low-pass filter.

FIG. 2F is a graph, schematically illustrating the variable gain behavior of variable amplifier 299B according to the present invention. The horizontal axis represents the magnitude (arbitrary units) of a signal S_{IN} received at the input of variable amplifier part 299B, the vertical axis represents the resulting gain γ_{V} (arbitrary units). For small signals, having a magnitude below a threshold R_{T}, the variable gain γ_{V} remains equal to zero. Only if the signal magnitude is above said threshold R_{T}, the variable gain γ_{V} is above zero. In principle, it is possible that the variable gain γ_{V} is switched between zero and a constant high value, but, as illustrated, the variable gain γ_{V} preferably increases proportionally with the signal magnitude, although this does not need to involve a linear relationship.

Now, control circuit 90 (FIG. 2A), with amplifier 99 implemented in accordance with FIG. 2D, operates as follows. The optical read signal S_{R} is monitored and processed to detect shocks. As long as no shocks are experienced, or for relatively small errors, the variable gain γ_{V}=0, so that the gain γ=γ_{C}, independent of the frequency of these errors.

For larger errors, having a signal magnitude above said threshold R_{T}, the variable gain is increased if the error frequency is outside the reject range of the filter 297. If the error frequency is within the reject range of the filter 297, the input signal S_{IN} of the variable amplifier part 299B is lower than the error signal magnitude, so that the gain increase is reduced. Close to the central frequency ω₀ of the filter 297, the suppression will be such that the input signal S_{IN} of the variable amplifier part 299B is lower than said threshold R_{T}, so that the variable gain γ_{V} remains equal to zero for such frequencies. As already mentioned above, stability is ensured when γ_{V}=0.

FIG. 2G is a graph, comparable to FIG. 2B, showing a Nyquist plot of the new closed loop frequency response G′(s) of the control loop, indicated by reference numeral 201, for an example wherein the filter 297 is a notch filter. For easy reference, original curve 101 of original closed loop transfer function G(s) is also shown. Original curve 101 may be regarded as illustrating the response of the inventive control loop for the case of small radial errors, whereas curve 201 illustrates the response of the inventive control loop for the case of large error magnitudes. The effect of the filter 297 can easily be recognized. In effect, the filter 297 shapes the closed loop frequency response in such a way that the response at the critical frequency ω_{CP} is lower than the response at other frequencies.

Original curve 101 may also be regarded as illustrating the response of a control loop without the filter 297 (which is equivalent to the inventive control loop with the filter 297 switched off), for the case of large error magnitudes and for a certain value of the constant gain γC, whereas curve 201 illustrates the response of the inventive control loop for the case of the same error magnitudes and the same value of the constant gain γC. In the case of a prior-art control loop (or inventive control loop with the filter 297 switched off), these error magnitudes lead to a variable gain γV setting which may be the same for all frequencies, resulting in curve 101. In the case of the inventive control loop (i.e. with the filter 297 switched on), the same error magnitudes lead to a variable gain γV setting which is relatively low around the critical frequency ωCP. Thus, the effect of the filter 297 is that the absolute value of RMIN is reduced. Consequently, the allowable maximum for the variable gain γV is increased.

It is noted that the exact value of the central frequency ω0 of the notch filter 297 depends on the critical frequency ωCP of the control loop, i.e. the frequency at which the transfer function G′(s) would have its minimum RMIN with the filter 297 switched off (i.e. with the filter transfer function being equal to 1 for all frequencies). Typically, the design is such that the control loop has a relatively high critical frequency ωCP, i.e. typically above 2000 Hz, which is well above the frequency range corresponding to mechanical shocks, so that the overall frequency response in the frequency range corresponding to mechanical shocks is substantially undisturbed.

In the example described, filter 297 is a notch filter. It is alternatively possible to use a low-pass filter having its cut-off frequency well above the frequency range in which shocks are to be expected. Since shocks typically have frequencies below 200 Hz, an adequate choice for such a cut-off frequency is in a range above 2000 Hz. Also, an adequate choice for such a cut-off frequency is approximately equal to the original critical frequency ωCP. However, since the critical point CP should be displaced to the right as much as possible, the cut-off frequency is preferably chosen to be below the original critical frequency ωCP.

In the case of the filter 297 being a notch filter, an adequate design choice would be to choose the central frequency ω0 of the notch filter to be equal to the frequency corresponding to the original critical point CP. However, in an ideal case as illustrated in FIG. 2G, the central frequency ω0 of the notch filter is chosen to be such that the closed loop transfer function G′(s) has two critical points CP1 and CP2, i.e. the lowest value RMIN for Re(G′) is obtained for two frequencies ω1 and ω2, one below ω0 and one above ω0.

Up till now, the operation of the non-linear controller 90 has been described for a case in which both the constant amplifier part 299A and the variable amplifier part 299B receive the radial error signal REn (albeit filtered signal γR in the case of variable amplifier part 299B). This already constitutes an improvement as compared to a linear controller 90 (which is equivalent to γV=0), and in fact this approach is satisfactory in cases in which only shocks or vibrations are experienced or in cases in which only high-frequency disturbances such as measuring noise or disc defects are experienced. In practice, however, it may happen that low-frequency disturbances (for instance, shocks) and high-frequency disturbances (for instance, disc defects or measuring noise) occur simultaneously. The low-frequency disturbances will cause the gain to be set relatively high, amplifying the high-frequency disturbances in an undesirable way.

To improve the performance, the present invention proposes the use of a state observer or estimator for estimating the radial error signal REn. This is illustrated in FIG. 3, which is a block diagram of an amplifier circuit 399 to replace amplifier 99 of FIG. 2A.

Amplifier 399 comprises a constant amplifier 399A and a variable amplifier 399B arranged in parallel, which may be identical to the amplifiers 299A and 299B, respectively, described above, so it is not necessary to repeat the explanation of these amplifiers. The output signals of these amplifiers 399A and 399B are added, represented by an adder 301, and the resulting output signal γR is processed by control signal generator 98 of FIG. 2A. This resulting output signal γR can be written as γR=γ_{V}S+γ_{C}R, wherein γ_{V}S indicates the output signal of the variable amplifier 399B while γ_{C}R indicates the output signal of the constant amplifier 399A.

Furthermore, a dynamic filter 397 is included in the signal input path of the variable amplifier 399B, which dynamic filter 397 may be identical to the dynamic filter 297 described above, so it is not necessary to repeat the explanation of this dynamic filter 397.

Amplifier 399 further comprises a state estimator 350 having a first input 351, a second input 352, and an output 353. At its first input 351, the state estimator 350 receives the output signal γ_{V}S of the variable amplifier 399B. At its output 353, the state estimator 350 provides a signal êR, which is an estimation of the radial error signal REn. This estimated error signal êR is received at the input of the dynamic filter 397. The constant amplifier 399A receives the radial error signal REn, as before.

At its second input 352, the state estimator 350 receives the difference δR between the radial error signal REn and the estimated error signal êR, represented by a subtractor 340.

The state estimator 350 is designed to calculate its output signal êR from the two input signals γ_{V}S and δR, using a model which describes the behavior of the control loop 100 as a whole, and using a model representing the behavior of disturbances.

It is noted that state estimators are known per se; therefore, a more elaborate description of the design and operation of the state estimator 350 will not be given here. It is noted, however, that state estimators are generally designed to “predict” or “estimate” the value of a parameter somewhere in the system which cannot, or not easily, be measured. In contrast, in the present invention, the state estimator 350 is used to estimate a parameter (i.e. radial error signal) which is available as a “measured” signal. Furthermore, for varying the gain, the estimated parameter êR is used instead of the actual “measured” signal REn, because it was found to result in an improved performance.

It is further noted that state estimators are generally designed to “predict” or “estimate” the value of a parameter on the basis of a linear model representation of the behavior of the system in which such an estimator is implemented. In contrast, in the present invention, the state estimator 350 takes into account the non-linear behavior of the control loop 100 as a whole, which is represented by the fact that the state estimator 350 receives the non-linear output signal γ_{V}S from the variable amplifier 399B. This makes the state estimator 350 a non-linear estimator.

It is further noted that, in the present invention, the state estimator 350 takes into account predefined information regarding the behavior of expected disturbances. This predefined information may relate to, for instance, a frequency spectrum. For instance, it may be assumed that measuring noise or disc defects have a relatively high frequency content.

All in all, the state estimator 350 behaves as a sophisticated low-pass filter operating on the radial error signal REn, and providing the input of the variable amplifier 399B with a filtered error signal êR without affecting the stability of the control system.

The state observer 350 is considered to be a system which calculates an output signal on the basis of its two input signals and on the basis of formulas describing the (assumed) behavior of the observed system (servo loop). These input signals are signals occurring in the observed system, which is a dynamic system, so said signals change as a function of time. The way in which said signals change depends on the output signal of the observer, while the output signal of the observer depends on its input signals. Thus, there is interaction between the observer system and the observed system. It is important that the state observer is a stable device. This means that, if the input signals to the observer are limited, the observer output signal is limited, and the difference δR converges to zero irrespective of the behavior of the observed system. Then the state observer has no influence any more on the dynamics of the observed system, and the behavior of the state observer, on the one hand, and the observed system, on the other hand, can be considered as being separated.

In a preferred embodiment proposed by the present invention, the state observer calculates its output signal in accordance with the following formulas:

êR=c^{T}·x;̂ (1a)

wherein x;̂ represents the observer state vector and êR represents the estimated error signal, i.e. the output signal of the state observer.

The input signal γ_{V}S at first input 351 is considered to comply with the following formula:

γ_{V}S=φ(êR) (1b)

wherein φ is a function describing the operation of the filter 397 and the controllable amplifier 399B.

The state observer calculates its observer state vector x;̂;\dot{} on the basis of the following formula:

x;̂;\dot{}=(A+b₁·c^{T})·x;̂+b₂·γ_{V}S+K·δR (1c)

wherein (A+b₁·c^{T}) is a matrix describing the linear dynamics of the controlled system, i.e. representing a model of the behavior of the servo system including the lens;
wherein b₂ is an input vector,
and K is a Kalman gain matrix.

Although there are several possible ways of defining a suitable Kalman gain matrix, a preferred method of defining a suitable Kalman gain matrix is based on a modified linear model structure, as follows:

e;~R=c^{T}·x;~+v (2a)

x;~;\dot{}=(A+b₁·c^{T})·x;\dot{}+b₁·w (2b)

wherein v represents high-frequency disturbances, i.e. disc errors, and w represents low-frequency disturbances, i.e. shocks and vibrations. Formula (2b) is a system equation, while formula (2a) is a measuring equation. The above linear model equations reflect the assumption that shocks and disc errors are associated with characteristic frequency ranges which can be separated.

With equations 2a and 2b, the constant Kalman gain matrix K is given by:

K=P·c (3)

wherein P=P^{T}>0 represents the error covariance matrix that is obtained by solving an algebraic Riccati equation. Due to the fact that w and v are scalar values, this Riccati equation is given by:

A·P+P·A^{T}+τb₁·b₁^{T}−P·c·c^{T}·P^{T}=0 (4)

Herein, all terms are determined by the model of the controlled system, except τ, which can freely be chosen. τ determines the filter performance with respect to high-frequencies and low-frequencies: if τ is relatively low, the filter performance is mainly determined by disc errors, while in the case of τ being relatively high, the filter performance is mainly determined by shocks and vibrations.

For the purpose of stability analysis, the linked system dynamics are given by the following formulas:

x;\dot{}=(A+b₁·c^{T})·x+b₂·γ_{V}S+b₁·(v+w) (5a)

x;̂;\dot{}=(A+b₁·c^{T})·x;̂+b₂·γ_{V}S+K·δR (5b)

with

γ_{V}S=φ(êR) (1b)

δR=REn−êR (5c)

REn=c^{T}·x+v+w (5d)

êR=c^{T}·x;̂ (5e)

Herein, formula 5a describes the model of the controlled system, and formula 5b describes the observer. The term b2·γVS introduces a non-linear coupling between the Kalman filter and the variable gain controlled system dynamics, but with the effect of having linear observer error dynamics, i.e.

x;̂;\dot{}−x;\dot{}=(A+b₁·c^{T})·(x;̂−x)+K·δR−b₁·(v+w) (6a)

which formula can be obtained by subtracting formulas 5a and 5b from each other.

Using formulas 5c, 5d, 5e: δR=cT·x+v+w−cT·x;̂ formula 6a can be written as:

x;̂;\dot{}−x;\dot{}=(A+(b1−K)·cT)·(x;̂−x)+(K−b1)·(v+w) (6b)

From formula 6b, it follows that, if the matrix (A+(b1−K)·c^{T}) is stable, the error δR=REn−êR converges to zero. It is noted that the matrix (A+(b₁−K)·c^{T}) is stable in view of the choice for the Kalman gain matrix K. With the error δR=REn−êR having converged to zero, formulas 5a and 5b can be rewritten by substitution:

γ_{V}S=φ(êR)=φ(REn)=φ(c^{T}·x+v+w) into formula 5a, and

γ_{V}S=φ(êR)=φ(cT·x;̂) into formula 5b, to give

x;\dot{}=(A+b1·cT)·x+b2·φ(cT·x+v+w)+b1(v+w) (5a′)

x;̂;\dot{}=(A+b1·cT)·x;̂+b2·φ(cT·x;̂)+K·δR (5b′)

These two rewritten formulas reflect a linear separation assumption, i.e. formulas 5a′ and 5b′ are independent of each other, i.e. the observer error dynamics are independent of the system dynamics.

The above procedure results in a suitable Kalman gain matrix, but, as mentioned, there are several possible ways of defining such a matrix. In any case, a suitable Kalman gain matrix should be stable (limited). It can be shown that, for a Kalman gain matrix to be stable, the real parts of all its eigenvalues should be non-positive, preferably negative. In other words: as long as none of the complex eigenvalues of the matrix has a positive real part, the matrix can be used, as will be clear to a person skilled in the art.

If the Kalman gain matrix is calculated by using the formulas 3 and 4 above, it can be shown that a stable Kalman gain matrix always results in the matrix (A+(b₁−K)·c^{T}) being stable and hence the error δR=REn−êR converging to zero.

It should be clear to a person skilled in the art that the present invention is not limited to the embodiments described above, but that several variations and modifications are possible within the protective scope of the invention as defined in the appending claims.

For instance, it is possible that the filter 397 and the variable amplifier 399B, and even the constant amplifier 399A, are integrated into one signal-processing component.

It is also possible that the filter 397 is arranged at the output of the variable amplifier 399B, in which case the variable amplifier 399B would directly receive the estimated error signal êR from the state estimator 350.

Furthermore, the subtractor 340 and the state estimator 350 may be implemented as a single device just receiving γ_{V}S and REn, in which case this single device would have an internal subtractor for calculating δR=REn−êR. It is further possible that the filter 397 is integrated in the state estimator 350, in which case the state estimator 350 would internally filter the estimated error signal êR and provide the input signal S_{IN} for the variable amplifier 399B.

The present invention has been explained with reference to block diagrams, which illustrate functional blocks of the device according to the present invention. It is to be understood that one or more of these functional blocks may be implemented in hardware, wherein its function is performed by individual hardware components, but it is also possible that one or more of these functional blocks are implemented in software, so that its function is performed by one or more program lines of a computer program or a programmable device such as a microprocessor, a microcontroller, etc.

1. A method of controlling a disc drive apparatus (1), the disc drive apparatus (1) comprising:
scanning means (30) for scanning a record track of a disc (2), said scanning means (30) comprising at least one read/write element (34) to be positioned with respect to the disc (2), and at least one detector (35) for generating a read signal (S_{R});
actuator means (50) for controlling the positioning of said at least one read/write element (34);
a control circuit (90) for receiving said read signal (S_{R}) and generating at least one actuator control signal (S_{CR}) on the basis of at least one signal component of said read signal (S_{R}), the control circuit (90) having at least one variable gain (γ);
said control circuit (90), said actuator means (50), said read/write element (34), and said detector (35) defining a control loop (100) having a critical frequency (ω_{CP}); the method comprising the steps of:
using a non-linear state estimator (350) to selectively set said gain (γ) to a first value for signal components having a frequency in a predefined range corresponding to said critical frequency (ω_{CP}) and to a second value for signal components having a frequency outside said range, said first value being lower than said second value.

2. A method according to claim 1, wherein, for all signal components, said gain (γ) has a constant part (γ_{C}) independent of the frequency or amplitude of such a signal component, and a variable part (γ_{V}) which depends on the frequency or amplitude of such a signal component, wherein said constant value (γ_{C}) corresponds to a linear and stable control design.

3. A method according to claim 2, comprising the steps of:
calculating an error signal (REn) on the basis of said read signal (S_{R});
processing said error signal (REn) with said constant gain value (γ_{C}) to obtain a first processed signal component (γ_{C}R);
using said non-linear state estimator (350) to calculate an estimated error signal (êR) on the basis of said error signal (REn);
processing said estimated error signal (êR) with said variable gain (γ_{V}) to obtain a second processed signal component (γ_{V}S);
combining said first and second processed signal components (γ_{C}R, γ_{V}S).

4. A method according to claim 3, comprising the steps of:
receiving said estimated error signal (êR);
dynamically filtering said estimated error signal (êR);
applying a variable gain (γ_{V}) to filtered signal components having a magnitude above a predefined shock threshold (R_{T}).

5. A method according to claim 3, wherein said non-linear state estimator (350) calculates said estimated error signal (êR) on the basis of, on the one hand, the difference (δR) between said error signal (REn) and said estimated error signal (êR) and, on the other hand, said second processed signal component (γ_{V}S).

6. A method according to claim 5, wherein said non-linear state estimator (350) calculates said estimated error signal (êR) in accordance with the following formula:
êR=cT·x;̂
wherein x;̂ represents the observer state vector, which is calculated in accordance with the following formula:
x;̂;\dot{}=(A+b1·cT)·x;̂+b2·γVS+K·δR
wherein (A+b1·cT) is a matrix describing the linear dynamics of the controlled system,
wherein b2 is an input vector,
and K is a stable Kalman gain matrix.

7. A method according to claim 4, wherein the step of dynamically filtering comprises the step of selectively suppressing signal components having a frequency in the proximity of said critical frequency (ω_{CP}).

8. A method according to claim 4, wherein said variable gain (γ_{V}) is proportional to the magnitude of the corresponding filtered estimated error signal (êR) components.

9. A method according to claim 1, wherein said actuator means (50) comprises a radial actuator (51), and said variable gain (γ) is a gain in the radial control loop for controlling said radial actuator (51).

10. A method according to claim 1, wherein said actuator means (50) comprises a focal actuator (52), and said variable gain (γ) is a gain in the focal control loop for controlling said focal actuator (52).

11. A method according to claim 1, wherein said actuator means (50) comprises a tilt actuator (53), and said variable gain (γ) is a gain in the tilt control loop for controlling said tilt actuator (53).

12. A control circuit (90) for use in a disc drive apparatus (1), the control circuit comprising:
an input (91) for receiving a read signal (S_{R}) from a detector (35);
at least one output (93) for providing at least one actuator control signal (S_{CR}) on the basis of at least one error signal component (REn) derived from said read signal (S_{R});
the control circuit (90) having a variable gain (γ);
the control circuit (90) being adapted to set its gain (γ) depending on whether or not shocks are experienced, and/or depending on the magnitude of shocks;
the control circuit (90) comprising:
a non-linear state estimator (350) designed to calculate an estimated error signal (êR);
a series connection of a dynamic filter (397) and a variable amplifier (399B), said dynamic filter (397) being designed to attenuate signal components having a frequency within a predefined frequency range;
wherein said series connection is coupled to receive said estimated error signal (êR).

13. A control circuit according to claim 12, wherein said non-linear state estimator (350) has a first input (351) coupled to receive the output signal (γ_{V}S) of said series connection.

14. A control circuit according to claim 12, comprising a subtractor (340) for calculating a difference signal (δR) between said error signal component (REn) and said estimated error signal (êR), wherein said non-linear state estimator (350) has a second input (352) coupled to receive said difference signal (δR).

15. A control circuit according to claim 12, wherein said dynamic filter (397) comprises a notch filter.

16. A control circuit according to claim 12, wherein said dynamic filter (397) comprises a low-pass filter.

17. A control circuit according to claim 12, further comprising:
a constant amplifier (399A) providing a constant gain (γ_{C}); and an adder (301) combining the output signals of said constant amplifier (399A) and said series connection (397; 399B);
wherein said constant amplifier (399A) is coupled to receive said error signal component (REn).

18. A disc drive apparatus (1) comprising:
scanning means (30) for scanning a record track of a disc (2), said scanning means (30) comprising at least one read/write element (34) to be positioned with respect to the disc (2), and at least one detector (35) for generating a read signal (S_{R});
actuator means (50) for controlling the positioning of said at least one read/write element (34);
a control circuit (90) for receiving said read signal (S_{R}) and generating at least one actuator control signal (S_{CR}) on the basis of at least one signal component of said read signal (S_{R}), the control circuit (90) having at least one variable gain (γ);
said control circuit (90), said actuator means (50), said read/write element (34), and said detector (35) defining a control loop (100) having a critical frequency (ω_{CP});
the control circuit (90) being adapted to perform the method of claim 1.

19. A disc drive apparatus (1) comprising:
scanning means (30) for scanning a record track of a disc (2), said scanning means (30) comprising at least one read/write element (34) to be positioned with respect to the disc (2), and at least one detector (35) for generating a read signal (SR);
actuator means (50) for controlling the positioning of said at least one read/write element (34);
a control circuit (90) according to claim 12 for receiving said read signal (SR) and generating at least one actuator control signal (SCR) on the basis of at least one signal component of said read signal (SR);
said control circuit (90), said actuator means (50), said read/write element (34), and said detector (35) defining a control loop (100) having a critical frequency (ωCP).

20. A disc drive apparatus according to claim 18, wherein said predefined frequency range of said dynamic filter (397) corresponds to said critical frequency (ωCP) of said control loop (100).

21. A disc drive apparatus according to claim 18, wherein said actuator means (50) is designed to control a radial position of said at least one read/write element (34) and/or to control an axial position of said at least one read/write element (34) and/or to control a tilt position of said at least one read/write element (34).

22. A disc drive apparatus according to claim 19, wherein said actuator means (50) is designed to control a radial position of said at least one read/write element (34) and/or to control an axial position of said at least one read/write element (34) and/or to control a tilt position of said at least one read/write element (34).
